(19) United States
(12) Patent Application Publication
(10) Pub. No.: US 2021/0004847 A1
(43) Pub. Date: Jan. 7, 2021

(54) MARKETING CONTENT MANAGEMENT SYSTEM

(71) Applicant: Esmerina Bisha, Irvine, CA (US)

(72) Inventor: Esmerina Bisha, Irvine, CA (US)

(21) Appl. No.: 17/024,281

(22) Filed: Sep. 17, 2020

Related U.S. Application Data
(63) Continuation-in-part of application No. 16/009,487, filed on Jun. 15, 2018, now abandoned.

(51) Int. Cl. G06Q 30/02; G06Q 30/06

(52) U.S. Cl. CPC G06Q 30/0203; G06Q 30/0631; G06Q 30/0282

(57) ABSTRACT

A marketing system is disclosed, comprising a marketing database configured to store a plurality of marketing material distributed by a business to a marketer via a network server. A marketing module receives marketing parameters input by the business, generates a marketing campaign, and distributes the marketing campaign via a plurality of social profiles through different marketing channels selected by the business. A plurality of contacts are associated with a marketer device or online social profiles. The plurality of contacts are selectable by the marketer such that the user selects at least a portion of the plurality of contacts to receive a plurality of marketing materials comprising the marketing campaign.

### CROSS-REFERENCE TO RELATED APPLICATIONS

The present application is a Continuation-In-Part application to U.S. Non-Provisional patent application Ser. No. 16/009,487 filed on Jun. 15, 2018, entitled “CONNECTING CONSUMERS WITH BRANDS, PRODUCTS, AND SERVICES—THE CONCEPT, METHOD AND/OR TECHNOLOGY BY WHICH SINGLE INDIVIDUALS, GROUPS OF INDIVIDUALS AND/OR ENTITIES CAN USE THEIR RESPECTIVE CONTACT NETWORKS TO PERFORM MARKETING AND/OR OTHER SERVICES ON BEHALF OF 3^{RD} PARTY BRANDS, PRODUCT, AND/OR SERVICE PROVIDERS FOR A REMUNERATION” the entire disclosure of which is incorporated by reference herein.

### TECHNICAL FIELD

The embodiments generally relate to computer implemented systems for collecting, managing, and distributing marketing content, as well as measuring content distribution performance and continuously optimizing it.

### BACKGROUND

Growing a business and connecting with potential customers has always been a major challenge for brands providing a product and/or service. Historically, this has been achieved through word-of-mouth, marketing programs, advertising, and the like. Companies use various channels to reach the consumer including television advertisements and promotions, radio, online advertising, etc. leaving consumers overwhelmed with advertisements to influence the consumer to make a buying decision. Growth of a business is highly dependent on the budget and performance of such marketing efforts.

While traditional advertising is effective, it can be costly to reach a large number of consumers. Many consumers entrust the recommendations and advice of others who have experience with a particular brand, product, and/or service; however, this form of advertising is passive and is not directly controlled by the company.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a marketing system, comprising a marketing database configured to store a plurality of marketing material distributed by a business to a marketer via a network server. A marketing module receives marketing parameters input by the business, generates a marketing campaign, and distributes the marketing campaign via a plurality of marketing channels selected by the business. A plurality of contacts are associated with a marketer device or online social media profiles. The plurality of contacts are selectable by the marketer such that the user selects at least a portion of the plurality of contacts to receive a plurality of marketing materials comprising the marketing campaign.

The system provides a marketing system to connect businesses and marketers using a computerized system. The system permits marketers to participate in third party merchant marketing campaigns in exchange for a pre-agreed upon remuneration or a reward. Marketers may utilize their network of friends, family, and social contacts as an asset to generate income, rewards, or other forms of compensation by distributing third-party content on behalf of a brand to their social networks.

In one aspect, a business database stores business information.

In one aspect, a marketer database stores interested to advertise individuals' information.

In one aspect, the marketer information includes individual marketer profile and social contacts information.

In one aspect, the contact information includes contact metrics comprising the number of social contacts associated with the marketer.

In one aspect, a marketing engine is in operable communication with the marketing module.

In one aspect, a compensation engine is in operable communication with the marketing engine.

In one aspect, the compensation engine receives contact metrics and marketing material from the marketing engine and determines a compensation amount via a compensation calculator.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the marketing system, according to some embodiments;

FIG. 3 illustrates a process flow diagram of the marketing system, according to some embodiments;

FIG. 4 illustrates a block diagram of the marketing engine, according to some embodiments; and

FIG. 5 illustrates a block diagram of the compensation engine, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a marketing system using a computerized system. The system permits marketers to participate in third party merchant marketing campaigns in exchange for remuneration or a reward. Marketers may utilize their network of friends, family, and social contacts as an asset to generate income, rewards, or other forms of compensation by distributing third-party content on behalf of a brand to their network.

The system allows businesses to reach a broad base of consumers through individuals and their connections with their social networks. This enables businesses to achieve digital word of mouth while rewarding marketers for promoting the business to their social networks. In such, the system is providing a means for brands, or product and services providers (i.e., businesses), to advertise to consumers using the social contacts and network of the marketers.

As used herein, the term “business” may refer to a brand or collection of brands, a product provider, a service provider, and the like.

As used herein, the terms “individual” and “marketer” relate to users of the system who distributes content to his/her social contacts on behalf of a brand or business in exchange for a remuneration.

In some embodiments, the system permits a business to select parameters of who they want to advertise their products (e.g., demographics, locations, etc.). Marketers provide their information during the registration and sign-up process. The system uses an algorithm that matches instructions received from brands with suitable marketers that fit the criteria. Brands do not see which marketer advertises on their behalf. Instead, the systems pairs brands with suitable marketers based on the marketer's profile. Brands are able to see marketers' information on an audit report, only after the marketing content/campaign has been distributed. In such, the system operates as a matching system between brands and marketers using a profile created from the interests, tendencies, and behaviors of the marketer to determine the favorable matches between the marketer and the brand.

In some embodiments, the system provides compensation to marketers at a fixed rate for reaching a predetermined number of individuals within their network. In such, the business pays a fixed fee for marketing services.

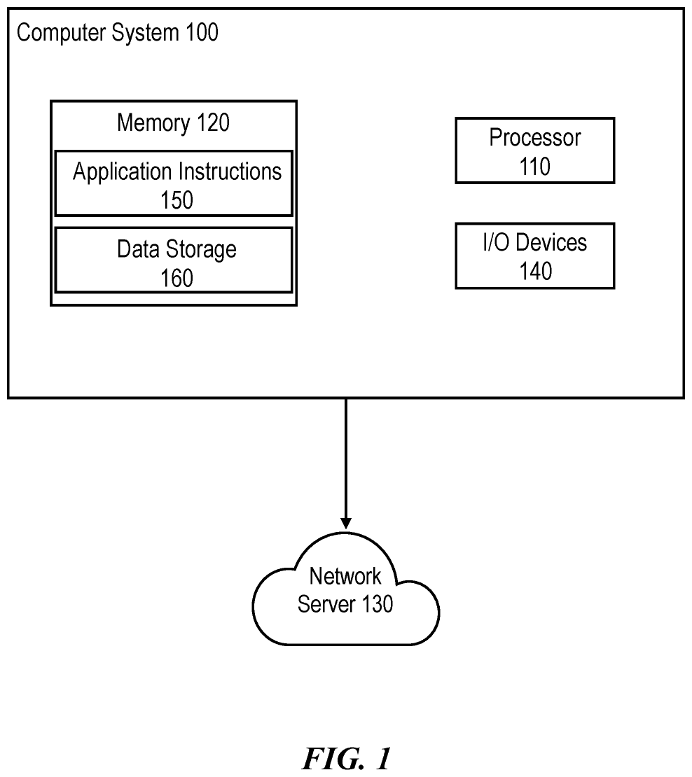

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network server 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network server 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C #, JAVA®, JAVASCRIPT®, PERL®, etc.).

The memory 120 may be configured to store user information including information for the business user(s), the individual(s), brand information, product information, service information, and the like.

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

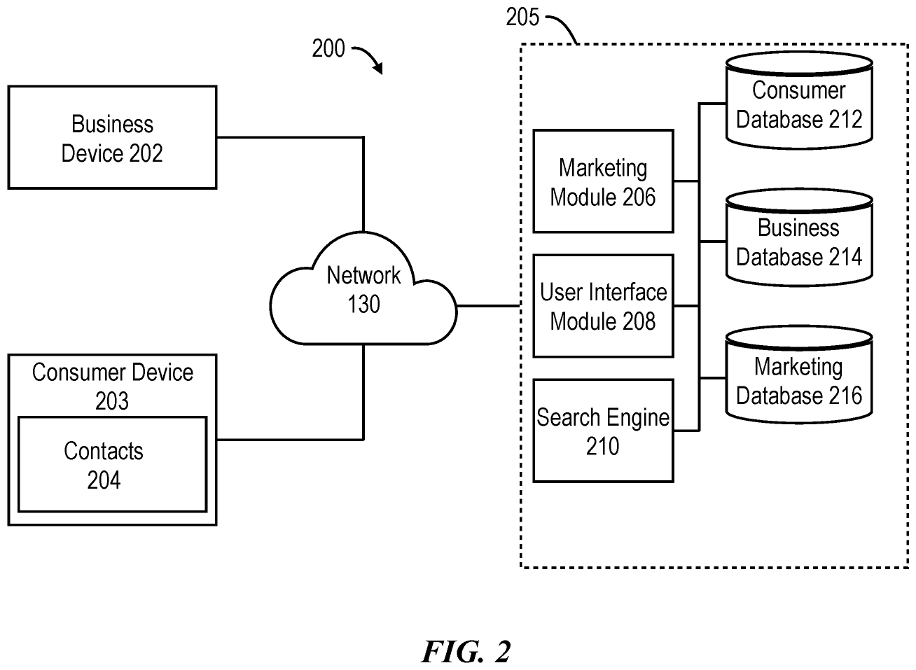

FIG. 2 illustrates a block diagram of the marketing system 200 which facilitates the connection between businesses and marketers. The marketing system comprises a business device 202 and marketer device 203 in operable communication with the service provider 205 via the network server 130. The business device 202 may be utilized by an employee or representative of the business, or via a marketing organization associated with the business. The marketer device 203 stores contacts or online social profile credentials 204 which correspond to a marketer performing marketing tasks on behalf of the business. The service provider 205 comprises a marketing module 206, user interface module 208, search engine 210, business database 214, and marketing database 216. The marketing module 206 permits the user to generate and process marketing information. The user interface module 208 is operable to provide functional aspects of the system onto the display of the business device 202 and/or the marketer device 203. The business database 214 stores business information including business contact information, product information, service information, brand information, and the like. The marketing database 216 is in operable communication with the marketing module 206 and stores marketing information including marketing materials, historical marketing data, and the like.

In some embodiments, the marketers contacts are stored on the user device or online profile.

In some embodiments, the business is registered and permitted to create a business profile in a server. The business may create a marketing persona (e.g., the targeted marketer lives in California, is female, between the ages of 25 and 45, and is interested in outdoor activities). If the marketer meets the criteria, the system automatically selects that specific marketer or group of marketers to serve the content to their networks.

In some embodiments, businesses may select marketing materials from the marketing database 216 with which they would like to distribute or otherwise interact. Similarly, businesses may create their own unique marketing materials. Further, the business may select marketing metrics and parameters, such as the number of impressions, the number of consumers they would like to reach, and the like. This permits the system to calculate a cost for the selected marketing effort based and number of consumers they want to reach and have selected. One skilled in the arts will readily understand that various additional parameters may be input by the business, which will alter the cost of marketing and the marketing campaign strategy.

In another embodiment, the marketer posts the marketing content to their social media profiles, media outlets, and the like. The business may select the marketer based on the contacts in the network of users within their social media networks. For example, the business determines that a particular marketer has a network comprising a high percentage of action sports enthusiasts and selects the marketer to advertise a corresponding product.

In some embodiments, a report generator provides a plurality of marketing reports to the business such that the business may analyze marketing efforts over time. This allows the business to optimize marketing efforts to increase their return on investment.

The system permits individuals to register and create a marketer profile and marketing persona (the marketing persona may also be created by the business as described hereinabove). Their potential compensation will be provided based on the marketing campaign parameters selected by the brand. For example, the potential compensation is calculated based off the number of contacts in their network. Marketers will be assigned marketing content to distribute to their contact network. Once distributed, the individual will receive compensation.

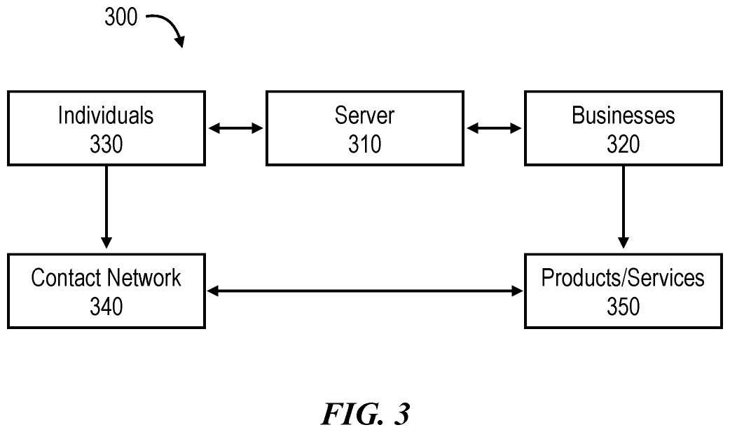

FIG. 3 illustrates a workflow 300 of the marketing system wherein a server 310 transmits and receives information to businesses 320 and individuals 330. The server 310 transmits content to the individual 330 and the individual's contact network 340 to provide them with information related to the business's products/services 350. The business 320 may also receive feedback from the individuals 330 and/or the individual's contact network 340.

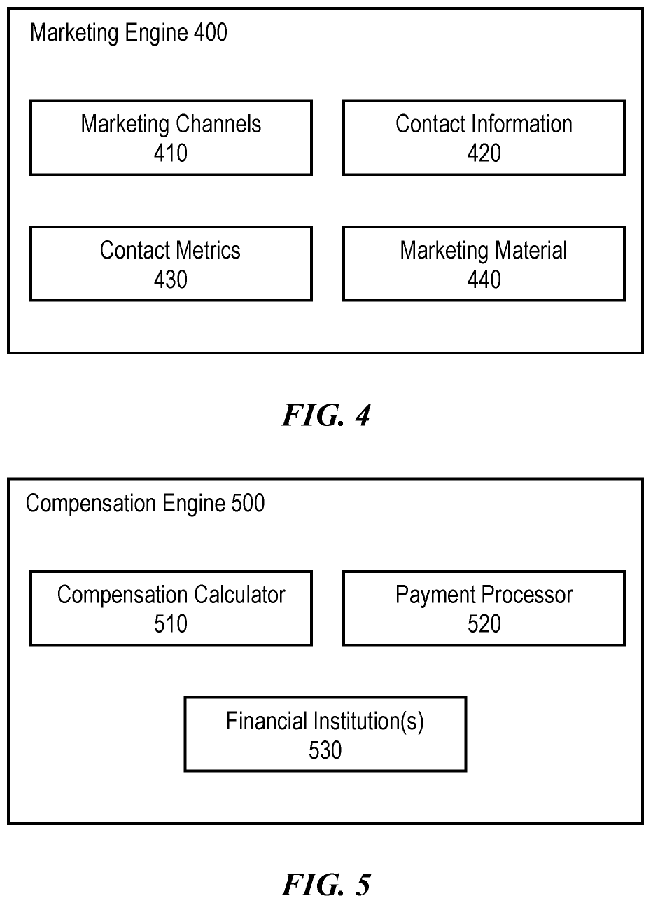

FIG. 4 illustrates a block diagram of the marketing engine 400 comprising marketing channels 410, contact information 420, contact metrics 430, and marketing material 440. Marketing channels 410 may include marketing outlets known in the arts, including types of media, media channels, and the like. Marketing material 440 may include various forms of media such as video, audio, electronic, and hardcopy media materials distributed to contacts of the marketer. The contact information 420 and contact metrics 430 are used by the marketing engine to distribute marketing material 440, which the marketer leverages for compensation.

FIG. 5 illustrates a block diagram of the compensation engine 500 comprising a compensation calculator 510 to receive marketing campaign information, including the marketing materials to be distributed, the contact information associated with the marketer, contact metrics (e.g., the number of contacts to which the marketing material is distributed), and the like. The payment processor 520 facilitates the transfer of compensation to and from the marketer via one or more financial institutions 530.

In some embodiments, the brand selects requirements for a marketer (e.g., the brand wants to reach 5-million people on a social media platform for a particular product, or group of products). Marketers which fit this profile will be selected to share/advertise the product information and various marketing materials to their networks for a predetermined fee.

In some embodiments, marketers are compensated based on various criteria including how many people they reached, how many channels (social media platforms, blogs, etc.) they posted to, previous performance metrics, inventory availability, etc.

One skilled in the arts will readily understand that the compensation may include monetary compensation as well as rewards, points, credits, promotions, or other forms of remuneration for performing the marketing service.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A marketing system, comprising:
a marketing database configured to store a plurality of marketing material distributed by a business to a marketer via a network server;
a marketing module to receive marketing parameters input by the business, generate a marketing campaign, and distribute the marketing campaign via a plurality of social profiles through different social channels selected by the business; and
a plurality of contacts associated with a marketer device or a social profile, the plurality of contacts selectable by the marketer, wherein the user selects at least a portion of the plurality of contacts to receive a plurality of marketing materials comprising the marketing campaign.

2. The system of claim 1, further comprising a business database to store business information.

3. The system of claim 2, further comprising a marketer database to store marketer information.

4. The system of claim 3, wherein the marketer information includes contact information.

5. The system of claim 4, wherein the contact information includes contact metrics comprising a number of contacts associated with the marketer.

6. The system of claim 5, further comprising a marketing engine in operable communication with the marketing module.

7. The system of claim 6, further comprising a compensation engine in operable communication with the marketing engine.

8. The system of claim 7, wherein the compensation engine receives contact metrics and marketing material from the marketing engine and determines a compensation amount via a compensation calculator.

9. A marketing system, comprising:
a marketing database configured to store a plurality of marketing material distributed by a business to a marketer via a network server;
a marketing module to receive marketing parameters input by the business, generate a marketing campaign, and distribute the marketing campaign via a plurality of social profiles through different marketing channels selected by the business using a user interface module;
a plurality of contacts associated with a marketer device or social profile, the plurality of contacts selectable by the marketer, wherein the user selects at least a portion of the plurality of contacts to receive a plurality of marketing materials comprising the marketing campaign; and
a payment processor to provide a compensation to the marketer corresponding to the distribution of the marketing campaign.

10. The system of claim 9, further comprising a business database to store business information.

11. The system of claim 10, further comprising a marketer database to store marketer information.

12. The system of claim 11, wherein the marketer information includes contact information.

13. The system of claim 12, wherein the contact information includes contact metrics comprising a number of contacts associated with the marketer.

14. The system of claim 13, further comprising a marketing engine in operable communication with the marketing module.

15. The system of claim 14, further comprising a compensation engine in operable communication with the marketing engine.

16. The system of claim 15, wherein the compensation engine receives contact metrics and marketing material from the marketing engine and determines a compensation amount via a compensation calculator.

17. The system of claim 16, wherein the business receives feedback from the marketer related to the marketing campaign.

18. The system of claim 17, wherein the compensation engine is in operable communication with at least one financial institution to provide the compensation to the marketer via the payment processor.

19. The system of claim 18, wherein the marketing channels comprise audio, video, text, and hardcopy marketing material.

20. A marketing system, comprising:
a marketing database configured to store a plurality of marketing material distributed by a business to a marketer via a network server;
a marketing module to receive marketing parameters input by the business, generate a marketing campaign, and distribute the marketing campaign via a plurality of social profiles through different marketing channels selected by the business using a user interface module;
a plurality of contacts associated with a marketer device or social profile, the plurality of contacts selectable by the marketer, wherein the user selects at least a portion of the plurality of contacts to receive a plurality of marketing materials comprising the marketing campaign;
a compensation engine to calculate, via a compensation calculator, a compensation amount; and
a payment processor to provide the compensation amount to the marketer corresponding to the distribution of the marketing campaign.
